(19) United States
(12) Patent Application Publication
(10) Pub. No.: US 2003/0171863 A1
(43) Pub. Date: Sep. 11, 2003

(54) Device and method for user-specifically adjusting a device, especially an automobile

(76) Inventors: Joerg Plumeier, Salzgitter (DE); Ulrich Kersken, Diekholzen (DE)

Correspondence Address: KENYON & KENYON, ONE BROADWAY, NEW YORK, NY, 10004, US

(21) Appl. No.: 10/258,699

(22) PCT Filed: Jan. 19, 2001
(86) PCT No.: PCT/DE01/00209

(30) Foreign Application Priority Data
Apr. 28, 2000 (DE) 100 21 068.6

(51) Int. Cl. G06F 7/00

(52) U.S. Cl. 701/35

(57) ABSTRACT

An apparatus and a method of user-specific adjustment of a device, in particular a motor vehicle (1, 1′), user-specific data (4) being stored on an external memory medium (3). The data is stored in the form of device-independent reference values (4), which may be used in conjunction with different devices and/or device models (1, 1′). The particular device (1, 1′) is able to enter the reference data (4) via an interface (2, 2′) into a processing unit (5, 5′) which converts the device-independent reference values (4) into device-specific adjustment values (6, 6′). With the help of these values, it is then possible to adapt the device individually to a user (8), e.g., the seat height of a motor vehicle.

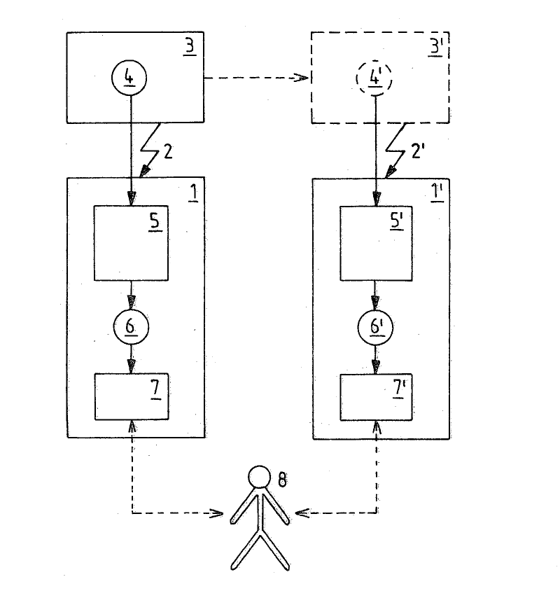

### FIELD OF THE INVENTION

The present invention relates to a method of user-specific adjustment of a device such as a motor vehicle, in particular such a method in which user-specific data is stored on an external memory medium, and the device is adjusted on the basis of this data. In addition, the present invention relates to an apparatus for user-specific adjustment of a device such as a motor vehicle in particular, containing an external memory medium for user-specific data as well as a processing unit which reads this data and is able to execute corresponding changes in the device.

### BACKGROUND INFORMATION

It is known that numerous complex industrial devices may be adapted specifically to a certain user with regard to different variables and parameters. A motor vehicle is considered as an example of such a device in the following discussion, although the present invention is not limited to such an embodiment. Adjustments of a modern motor vehicle which are adaptable to the user (driver or passenger) include, for example, the height and position of the seat, the inclination of the backrest, the adjustment of rearview mirrors, the interior temperature in the vehicle, the preferred volume and/or transmitter adjustment of a radio and the like.

There are known motor vehicles in which the variable adjustments for different users, as mentioned above, are stored on a memory medium assigned to the user. Then by using these adjustment values, different users may use the same vehicle, in which case they will find the adjustments which they prefer and which they perceive as comfortable. User-specific retrieval of device adjustments may be based on simple identification of the user, the particular adjustments being stored in the device itself and being made available from there after identification of the user. In addition, it is also possible to store the user-specific adjustments on an external memory medium, which the user must then provide for the vehicle, so that data stored therein may be entered and the corresponding changes in adjustments may be implemented. These user-specific adjustments are then stored in a device-specific format in the case of the known systems, i.e., in the form “seat in latch 3,” “backrest in position 5,” etc. for example. Therefore, if a user wants to use a different vehicle, he cannot use this data.

In addition, it is a disadvantage of the known systems that there is no means of checking on whether the adjustments made by the user are also appropriate from an objective standpoint. For example, it is known that many drivers and passengers do not assume an optimum seat position in a vehicle from an ergonomic, i.e., physiological, standpoint. On a longer trip, this results in premature fatigue and stress.

### DESCRIPTION OF THE PRESENT INVENTION, OBJECT, SOLUTION, ADVANTAGES

Against this background, it was the object of the present invention to provide a method and an apparatus for user-specific adjustment of a device such as a motor vehicle in particular, which will allow an improved and simplified means of determining the adjustment values.

This object is achieved by a method having the features of claim 1, a method having the features of claim 5 and an apparatus having the features of claim 6. The corresponding subclaims describe advantageous embodiments.

In the first method of user-specific adjustment of a device, in particular a motor vehicle, user-specific data is stored on an external memory medium, and the device is adjusted on the basis of this data. This method is characterized in that this data includes device-independent reference values on the whole or at least in part. The use of device-independent reference values for coding the user-specific adjustments has the advantage that with the data stored on the memory medium, a user is able to use different devices, e.g., to drive different models of vehicle, and will find his preferred adjustments in each case. Through the method according to the present invention, the manner of individualizing devices with the user-specific adjustment option is supplemented, i.e., completed, because now it is not only possible to adapt one device or one device model to different users, but in addition, a user may also find different devices and/or device models having optimum adjustments without having previously performed an adjustment procedure on that device.

In addition to the convenience in changing device models, the method according to the present invention also has the additional advantage that since the device adjustments are based on device-independent reference values, the adjustments are objectified and made comparable, which makes it possible to detect and correct faulty adjustments.

Various methods are available for obtaining device-independent reference data. If there is no known analytical relationship between device-specific data and device-independent reference data, or if the relationship is too complex, the reference values may also be determined empirically. The reference values may include, for example, the device-specific adjustments of a certain standard device. By comparing the adjustments made by different users in this standard device and other devices, exemplary data records could then be obtained for representation of a certain adjustment by different device-specific adjustment parameters. These may then be classified through the above-mentioned adjustments of the standard device or through another abstract parameter representation and thus may be coded independently of the device. Ultimately, this is a mathematical problem of representing a background variable (the user-specific adjustment) in different coordinate systems (device-specific parameters of the adjustment), and it is important to empirically determine the analytically unknown relationship between the coordinates and the variable behind them to the greatest possible extent. Statistical methods or artificial neural networks may be used for this purpose, e.g., as adaptive images.

The reference values may be preferably biometric data of the particular user. The use of biometric data as device-independent reference values is based on the analytical understanding that many device adjustments such as the seat height or seat position are determined by such biometric data. This biometric data may thus be used expediently for coding the user-specific adjustment, because it depends only on the user and is independent of the particular device. Furthermore, biometric data has the advantage that it may be obtained directly without the involvement of a device and may be stored on the memory medium. Thus, a user no longer needs to make device adjustments first in at least one device. In addition, it is advantageous that the conversion of biometric data to device adjustments is left up to the device itself and thus takes place automatically. This ensures that the device adjustments will fit optimally to the biometric data in an objective sense, i.e., the data may take into account ergonomic or physiological rules and findings. Unfavorable device adjustments made by the user himself without regard for such rules may thus be prevented.

According to a refinement of this method, the device-independent reference values may be obtained by converting predetermined device adjustments. In other words, the device-independent reference values are not preselected, as is the case in implementation of a user-specific adjustment, with the adjustment of the device being performed on the basis of these reference values, but instead the starting point is a device adjustment performed by the user in the traditional manner. This device adjustment is then coded in device-independent reference values which are subsequently available for use on other devices and/or other device models. With this method it is thus possible to determine the device-independent reference values without the user himself having to know the relationship between the device adjustment and the reference values. Instead, it is sufficient for the user to perform an individually adapted adjustment once on a certain device, and this adjustment is then available in a device-independent coded form for use on other types of devices.

The present invention also relates to a method of user-specific adjustment of a motor vehicle, characterized in that certain individual adjustments are varied during the use of the vehicle. This method may include in particular additional features of the type mentioned above, i.e., it may allow coding of the user-specific adjustments in device-independent reference values. With this method it is possible to achieve greater comfort and a better individual adjustment of the vehicle because the constant adjustments usually performed are not always optimum. A preferred example of an individual adjustment which may be varied during the use of the vehicle is the adjustment of the driver's seat and/or the passenger's seat. The static seat position usually maintained while driving results in a unilateral stress on certain muscle groups and body parts. These problems may be avoided with the method according to the present invention for dynamic adjustment, i.e., alteration of the adjustments. Due to the variations in seat position, fatigue is prevented during a lengthy trip and blood circulation is improved. The changes in adjustments may be controlled autonomically according to a predetermined pattern, i.e., program, or they may be regulated and/or initiated by measurements of the driver's condition as needed. The changes must of course remain within a certain framework within which the adjustments are still appropriate for the given user.

The present invention also includes an apparatus for user-specific adjustment of a device, in particular a vehicle which contains an external memory medium for user-specific data as well as a processing unit which is capable of reading this data and executing corresponding changes in the device accordingly. This apparatus is characterized in that the processing unit is equipped to be able to convert data in the form of device-independent reference values into device-specific adjustment values. By using this apparatus, it is thus possible to adjust a device such as a motor vehicle individually for a user with regard to various parameters, the data of the individual adjustment being stored in the form of device-independent reference values on an external memory medium. This makes it possible for the apparatus to adapt the device individually to different users without these users first having to make any adjustment in the device itself Instead, it is sufficient for the users to bring along their user-specific data in the form of device-independent reference values stored on the external memory medium. Equipping various devices with one apparatus each according to the present invention, adapted to the particular device, thus makes it possible for a user to change between these devices without any problem, in which case the user will find each device having optimum adjustments in each case.

According to a refinement of this apparatus, the processing unit is equipped to be able to convert device-specific adjustment values into device-independent reference values. The processing unit is thus able to perform the conversion between device-specific adjustment values and device-independent reference values in both directions. The return direction makes it possible in particular for a user to perform adjustments on the device in the traditional manner until the device has been optimally adjusted to his wishes. The adjustments performed in this way may then be stored via the processing unit in the form of device-independent reference values and are then available to the user for use on other devices and/or device models without requiring a new adjustment procedure there.

The external memory medium is preferably a chip card, a mobile telephone, or a computer. The computer is preferably in the form of a small portable device such as a personal digital assistant (PDA) or a laptop. Such devices have the required internal memory for storing user-specific data, and they are also widely available, so that a separate external memory medium is not necessary.

In addition, the external memory medium and the processing unit preferably have means for wireless data transmission between the memory medium and the processing unit. The data transmission may take place by wireless or infrared transmission in particular. Wireless transmission of data makes it possible for the user to transmit his user-specific data to the device with a low complexity.

According to another refinement of the apparatus, the processing unit may be equipped to be able to execute changes in adjustments during operation of the device autonomically and, e.g., continuously or intermittently. Such changes in adjustments have proven beneficial, especially in a vehicle for certain parameters, because a constant static adjustment could be a disadvantage here. This is true, for example, of the adjustment of the seat, where a change during a long trip is capable of preventing fatigue and improving blood circulation. Such a change in adjustments has independent inventive relevance because it is also capable of achieving its benefits independently of the use of user-specific and device-independent reference values.

### BEST WAY FOR EXECUTING THE PRESENT INVENTION

The present invention is explained in greater detail below as an example with the help of the FIGURE.

The only FIGURE shows schematically the device-independent storage and use of user-specific adjustments.

The device indicated in the left part of the FIGURE, which may be a motor vehicle 1, for example, contains a wired or preferably a wireless interface 2 to an external memory medium 3. External memory medium 3 may be, for example, a chip card according to International Standard ISO 7816. User-specific data 4, which may be transmitted via interface 2 to vehicle 1, is stored on chip card 3.

According to the present invention, user-specific data 4 includes reference values in a device-independent format. These reference values are preferably formed by biometric data of the user such as height, weight, leg length and the like.

A processing unit 5 in motor vehicle 1 calculates device-specific adjustment values 6 on the basis of device-independent reference values 4. In other words, biometric data on height, for example, may be converted to a suitable seat position adjustment, and this seat position adjustment may be expressed in the form of device-specific adjustment values 6, such as “seat in latch 3.” Device-specific adjustment values 6 may be applied to the device components to be adjusted, such as seats or rearview mirrors or to functions 7, e.g., the interior temperature, in order to set them to the adjustment value. After implementation of the adjustments, motor vehicle 1 is in a state in which it is optimally adapted to individual user 8.

The special advantage of the present invention is achieved through the fact that reference values 4 are independent of the device. This means that a completely different device 1′, e.g., a different model of a motor vehicle, may also be adapted individually to user 8 by using the same values 4 on memory medium 3. For the user there is no difference in operation in this regard, because he uses same memory medium 3 and same reference values 4 to transmit reference values 4 to the other device 1′ via a suitable interface 2′. Reference values 4 are then converted by a processing unit 5′ in the other device into device-specific adjustment values 6′ which may differ greatly from adjustment values 6 of first device 1. After implementation of the adjustments on the device components, i.e., functions 7′, device 1′ is in a condition which likewise has an optimum adjustment for user 8.

The present invention thus makes it possible to use the reference values stored on external memory medium 3, these values being directly biometric characteristics of the user, for example, or other standardized values, for completely different devices 1, 1′ such as motor vehicles from different manufacturers or different model series from the same manufacturer. Only one-time storage of the reference values on memory medium 3 is necessary for this purpose.

For the case when multiple devices 1, 1′ store their adjustments on an external memory medium 3, the required memory space and thus the size and price of the memory medium are reduced, because only one reference value need be stored for each variable instead of having to store multiple device-specific adjustment values.

Input, i.e., storage of user-specific adjustments 4, may take place in such a manner that user 8 performs his adjustments for the first time “by hand” in the traditional manner on any desired device 1 or 1′, and device and/or processing unit 5 or 5′ then converts device-specific adjustment values 6 or 6′ into device-independent reference values 4 and stores them on memory medium 3 via interface 2 or 2′.

In many cases it is also possible to store the reference values directly on memory medium 3, i.e., without performing adjustments on a device 1 or 1′. This is possible in particular with known and easily ascertainable biometric values such as height.

What is claimed is:

1. A method of user-specific adjustment of a device, in particular a motor vehicle (1, 1′), user-specific data being stored on an external memory medium (3) and the device being adjusted on the basis of this data,
wherein the data includes device-independent reference values (4) on the whole or in part.

2. The method as recited in claim 1,
wherein the reference values (4) contain biometric data.

3. The method as recited in claim 1 or 2,
wherein the reference values (4) are obtained by converting predetermined device adjustments (6, 6′).

4. The method of user-specific adjustment of a motor vehicle (1, 1′) in particular as recited in at least one of claims 1 through 3,
wherein certain individual adjustments are varied during the use of the vehicle.

5. The method as recited in claim 4,
wherein the position adjustment of the seat is varied continuously within limits.

6. An apparatus for user-specific adjustment of a device, in particular a motor vehicle (1, 1′), containing an external memory medium (3) for user-specific data (4) as well as a processing unit (5, 5′) which reads this data and is able to execute corresponding changes in the device (1, 1′),
wherein the processing unit is equipped to be able to convert data in the form of device-independent reference values (4) into device-specific adjustment values (6, 6′).

7. The apparatus as recited in claim 6,
wherein the processing unit (5, 5′) is equipped to be able to convert device-specific adjustment values (6, 6′) into device-independent reference values (4).

8. The apparatus as recited in one of claims 6 or 7,
wherein the external memory medium is a chip card (3), a mobile telephone, or a computer.

9. The apparatus as recited in at least one of claims 6 through 8,
wherein the external memory medium (3) and the processing unit (5, 5′) have means for wireless data transmission, preferably by wireless or infrared.

10. The apparatus as recited in at least one of claims 6 through 9,
wherein the processing unit (5, 5′) is equipped to be able to execute changes in adjustments during operation of the device (1, 1′) autonomically.
